(19) United States
(12) Patent Application Publication
(10) Pub. No.: US 2009/0142439 A1
(43) Pub. Date: Jun. 4, 2009

(54) Pre-Heater of Resin Material

(75) Inventor: Gregory Michael COOKE, Bolton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/949,896

(22) Filed: Dec. 4, 2007

(51) Int. Cl. B29C 45/72; F28D 15/00

(52) U.S. Cl. 425/548; 165/104.19; 425/547

(57) ABSTRACT

The invention is an resin-processing machine operable to process resin material. It includes a hydraulic circuit operable to circulate hydraulic fluid through the resin-processing machine in order to motivate components of the resin-processing machine. A heat exchanger assembly extracts heat from at least a portion of the hydraulic fluid in the hydraulic circuit after it passes through the resin-processing machine. The heat exchanger assembly transfers at least a portion of the heat extracted from the hydraulic circuit to the resin material prior to processing of the resin material by the resin-processing machine.

### FIELD OF INVENTION

The present invention generally relates to the processing of resin material. More specifically, the present invention relates to the preparation of resin material prior to its use in an injection unit.

### BACKGROUND OF INVENTION

The injection molding process typically comprises preparing a resin material (typically a polymeric or sometimes metal material) in an injection unit of an injection unit for melting, injecting the now-melted material under pressure into a closed and clamped mold, solidifying the material in its molded shape, opening the mold and ejecting the part before beginning the next cycle. The molding material typically is supplied to the injection unit from a hopper in the form of pellets or powder. The injection unit transforms the solid material into a molten material (sometimes called a “melt”), typically using a feed screw, which is then injected into a hot runner or other molding system under pressure from the feed screw or a plunger unit. A shut off valve assembly is typically provided to stop and start the flow of molten material from the barrel to the molding system.

Some examples of known molding systems having such an injection unit are: (i) the HyPET™ Molding System, (ii) the Quadloc™ Molding System, (iii) the Hylectric™ Molding System, and (iv) the HyMet™ Molding System, all manufactured by Husky Injection Molding Systems, Inc.

The resin material often needs to be prepared before processing. This can including drying the resin material (such as with PET resin) or preheating the resin material. Preprocessing is usually done with equipment auxiliary to the molding system, requiring additional power consumption to run the auxiliary equipment. Efforts have been made to reduce the power consumed for resin pre-processing. For example, U.S. Pat. No. 4,573,897 to Piazzola (published Mar. 4, 1986) teaches a system for extruding, drawing, vacuum molding or processing, or the like hot processing of plastomers or elastomers, which can conveniently utilize the hot air from the cooling process of its heated component parts. The system makes use, to heat the extruder cylinder, of ventilated electric thermal units wherein ventilation is performed in closed circuit fashion. In particular, arrangements are made to convey the hot air from the cited electric thermal units, through specially provided ducting, to areas of the system where application of heat is required.

Japanese patent 56,144,141A2 (published Nov. 10, 1981) teaches a method wherein the exhaust port of a cylinder cover and the interior of a resin supplying hopper are communicated. Hot wind discharged from the exhaust port 15 is introduced into the resin supplying hopper 9 by a blower 17 through a communicating duct 16 and dries and preheats the resin in the resin supplying hopper 9. In this case, the heat capacity of the hot wind discharged from the exhaust port 15 is different in accordance with the revolving speed of a screw in the cylinder 8, however, a driving motor for the blower 17 is controlled at a revolving speed in accordance with the revolving speed of a driving motor for the screw and the blower induces the heat capacity of the hot wind which is suitable for the revolving number of the screw, therefore, the most suitable hot wind temperature may be obtained. When the temperature in the communicating duct 16 has become higher than a predetermined temperature, a temperature indicating and adjusting meter 20 adjusts a wind volume adjusting valve 21 in accordance with a signal from a thermometer 19 and the hot wind of a constant temperature is introduced into the resin supplying hopper 9 at all the times.

U.S. Pat. No. 6,755,640 to Bauer et al (published Jun. 29, 2004) teaches a plastics injection molding machine includes a heatable plasticizing cylinder having an inlet side for incoming plastic material and a machine drive, and an injection mold receiving the plastic material from the plasticizing cylinder for making an injection molded article. Acting between the machine drive and the inlet side of the plasticizing cylinder is a heat transport system for preheating the incoming plastic material with waste heat generated by the machine drive to thereby realize a recovery of energy. The heat transport system 24 includes a circulating pump 26, a first heat exchanger 28 in the area of attachment flange 22 at the upstream end of the plasticizing cylinder 10 for cooling the hydraulic screw drive 14, and a second heat exchanger 30 for cooling the central unit 20.

### SUMMARY OF INVENTION

According to a first broad aspect of the present invention, there is provided a resin-processing machine operable to process resin material. The resin-processing machine comprises:
a hydraulic circuit operable to circulate hydraulic fluid through the resin-processing machine to motivate components of the resin-processing machine; and
a heat exchanger assembly, operable to extract heat from at least a portion of the hydraulic fluid; and wherein
the heat exchanger assembly transfers at least a portion of the heat extracted from the hydraulic fluid to the resin material prior to processing of the resin material by the resin-processing machine.

According to a second broad aspect of the invention, there is provided a heat exchanger assembly, operable to extract heat from a hydraulic circuit after having passed through an resin-processing machine, and wherein
the heat exchanger assembly transfers at least a portion of the heat extracted from the hydraulic circuit to a supply of resin material prior to processing of the resin material by the resin-processing machine.

According to a third broad aspect of the invention, there is provided a method for preheating a supply of resin material prior to its processing in a resin-processing machine, the method comprising:
transferring heat from the resin-processing machine to hydraulic fluid in a hydraulic circuit located within the resin-processing machine;
circulating the hydraulic fluid into a heat exchanger assembly;
transferring heat from the hydraulic circuit to the supply of the resin material via the heat exchanger assembly.

### DETAILED DESCRIPTION OF DRAWINGS

A better understanding of the non-limiting embodiments of the present invention (including alternatives and/or variations thereof) may be obtained with reference to the detailed description of the non-limiting embodiments of the present invention along with the following drawings, in which

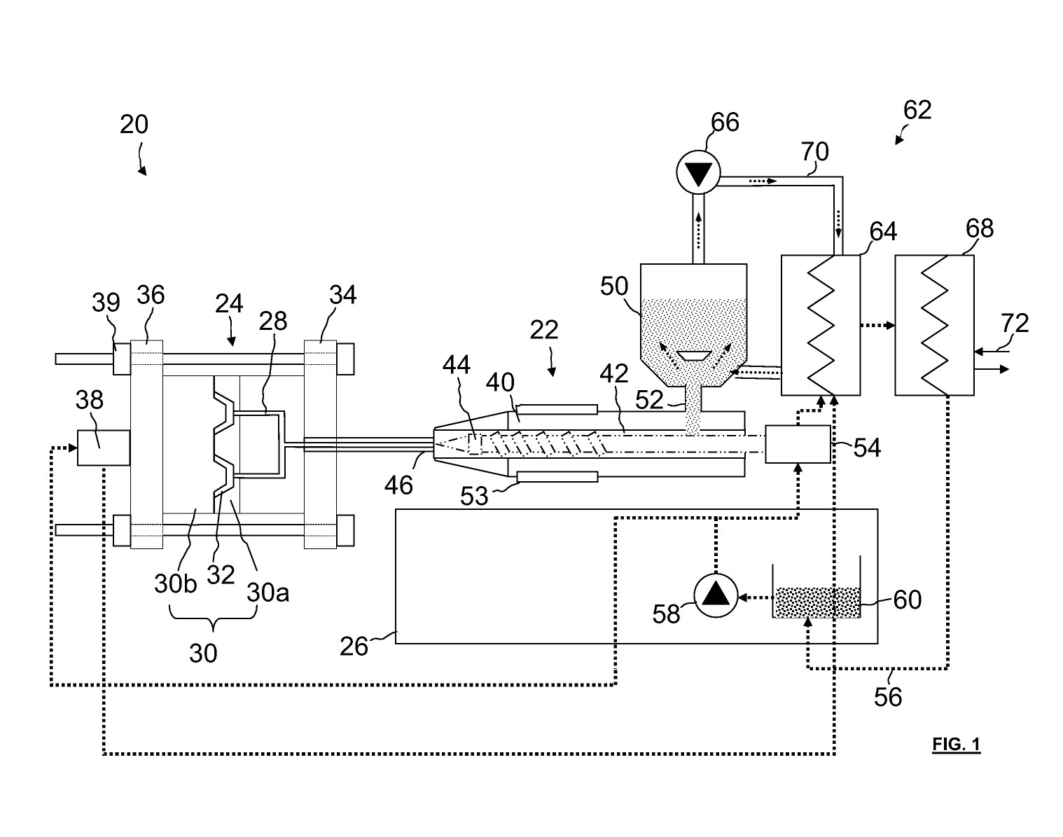

FIG. 1 shows a schematic view of an injection molding machine according to a first exemplary embodiment of the invention;

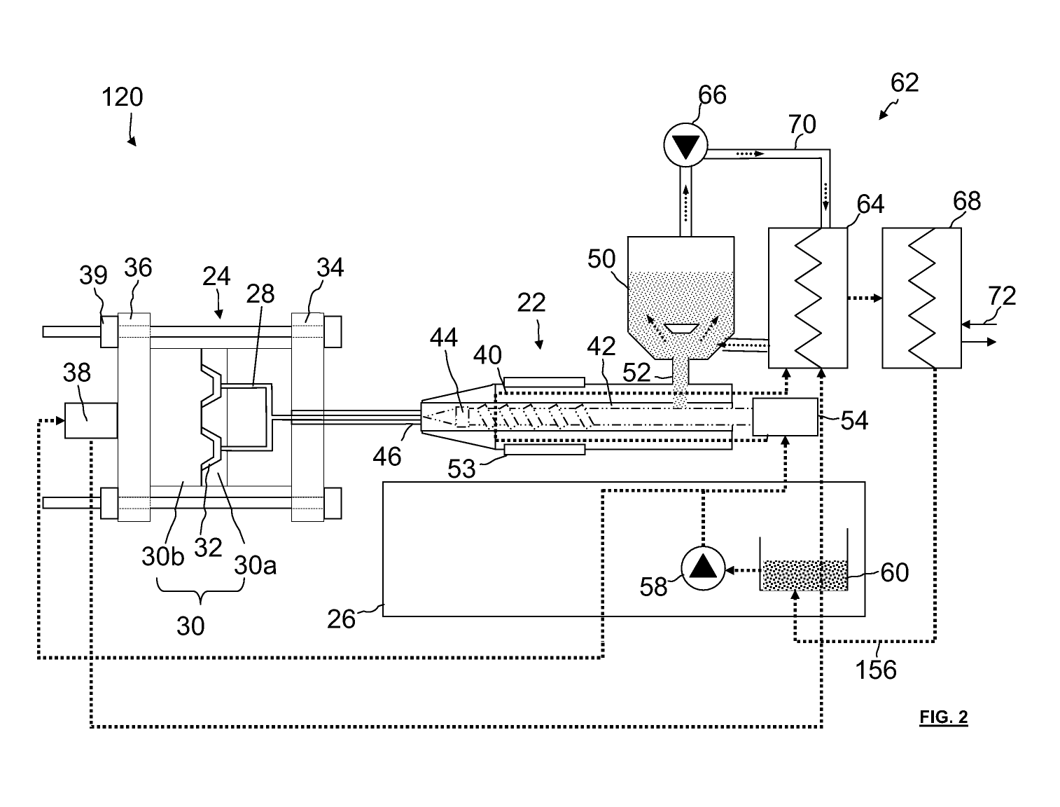

FIG. 2 shows a schematic view of an injection molding machine according to a second exemplary embodiment of the invention;

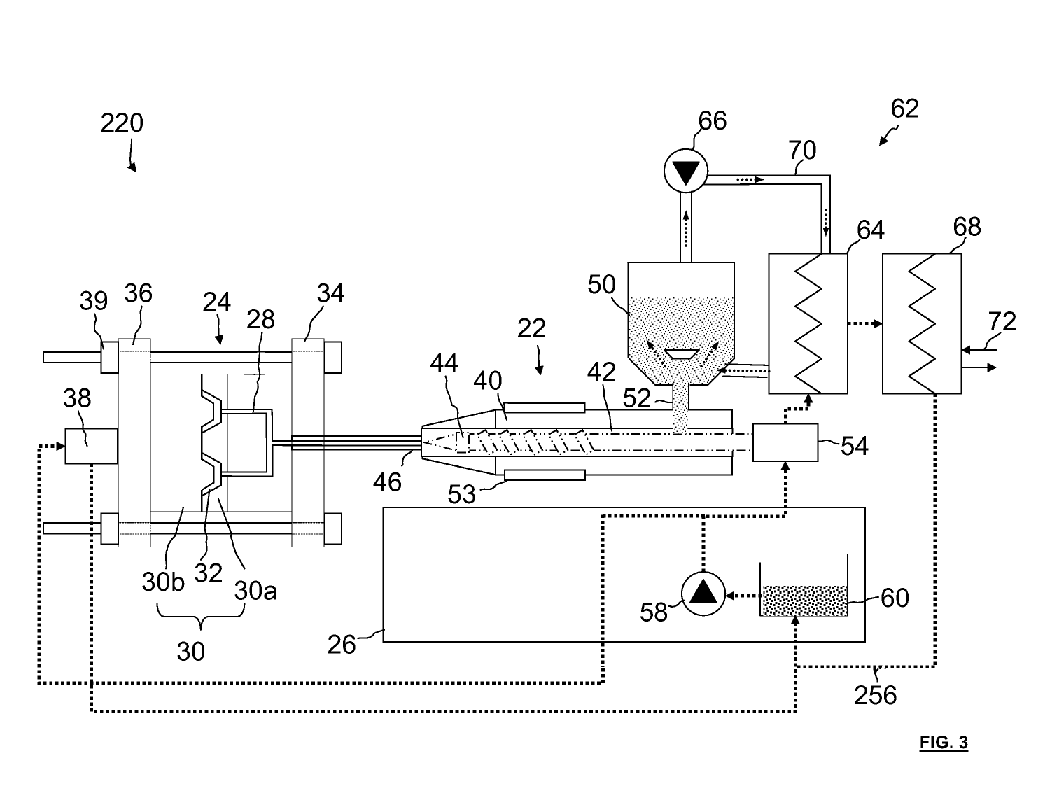

FIG. 3 shows a schematic view of an injection molding machine according to a third exemplary embodiment of the invention;

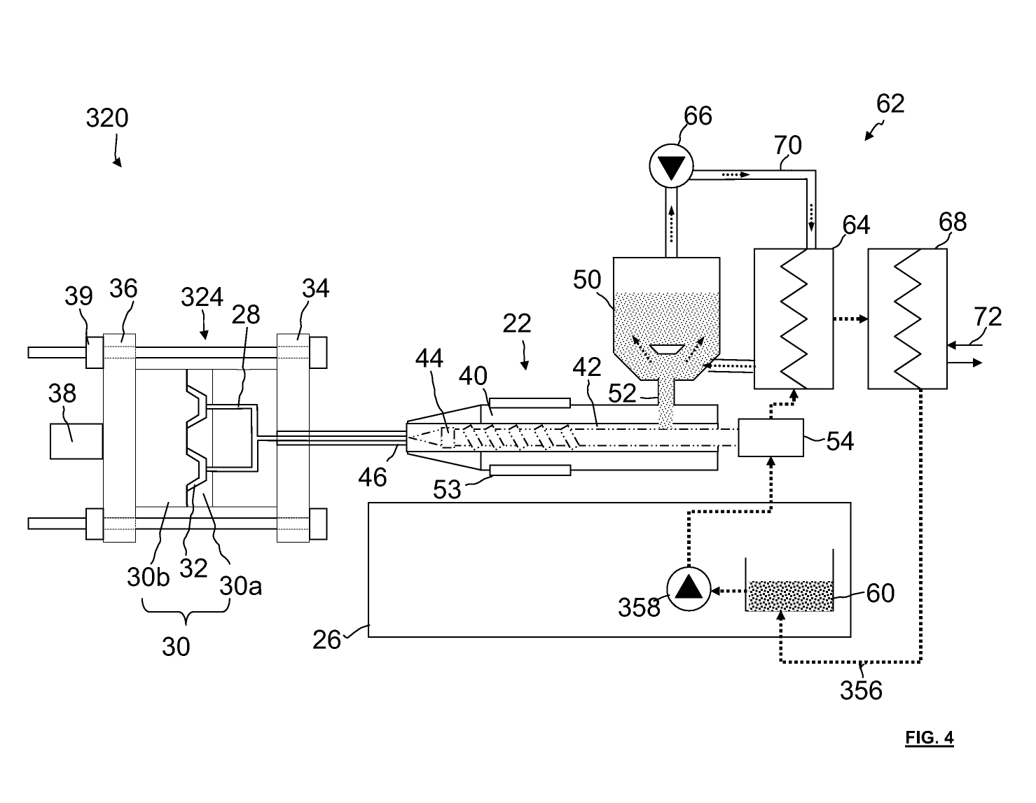

FIG. 4 shows a schematic view of an injection molding machine according to a fourth exemplary embodiment of the invention;

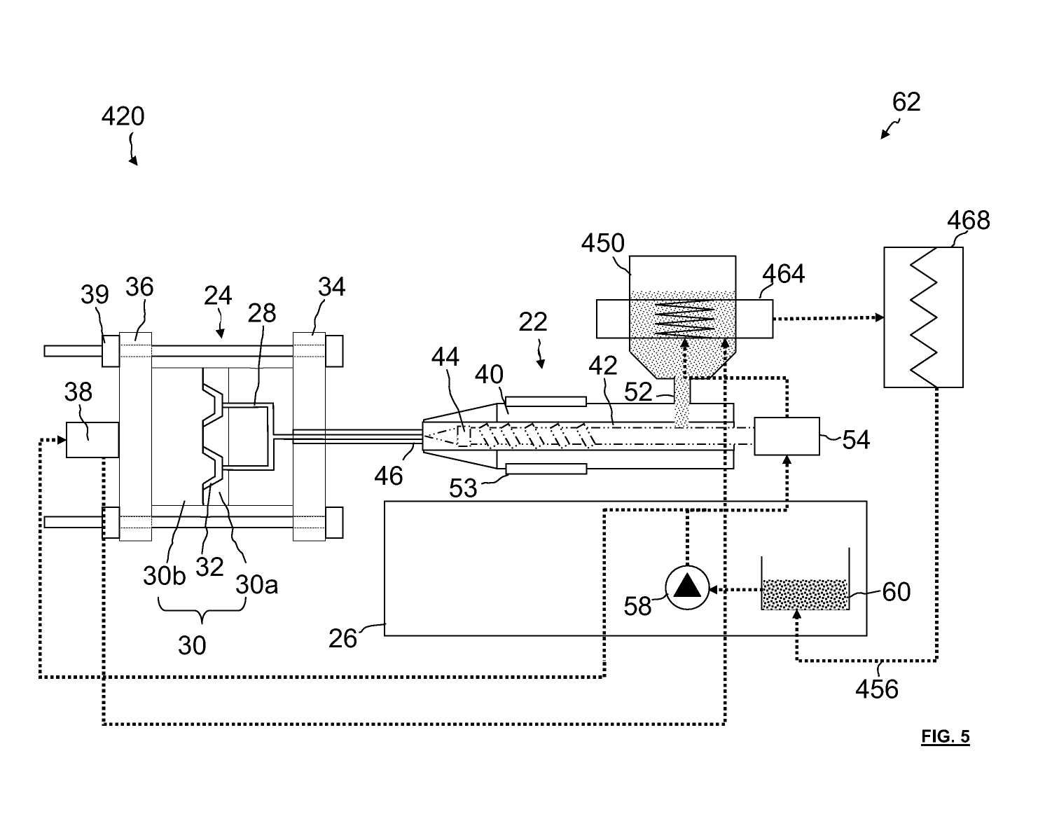

FIG. 5 shows a schematic view of an injection molding machine according to a fifth exemplary embodiment of the invention;

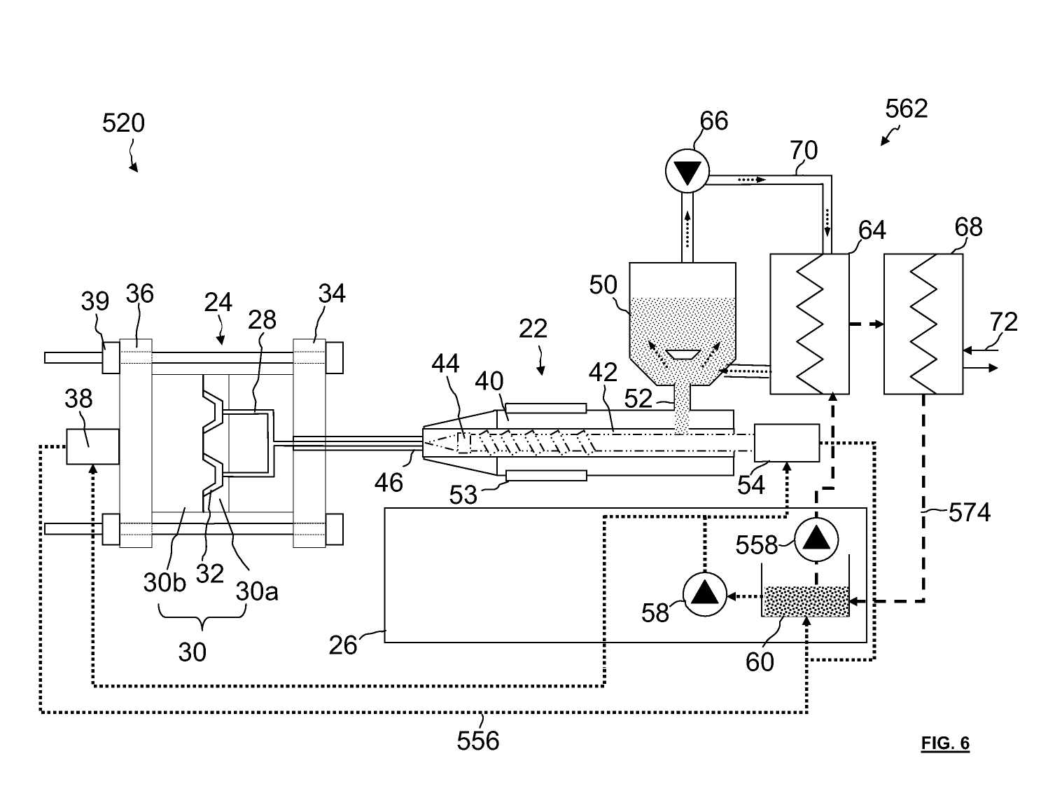

FIG. 6 shows a schematic view of an injection molding machine according to a sixth exemplary embodiment of the invention; and

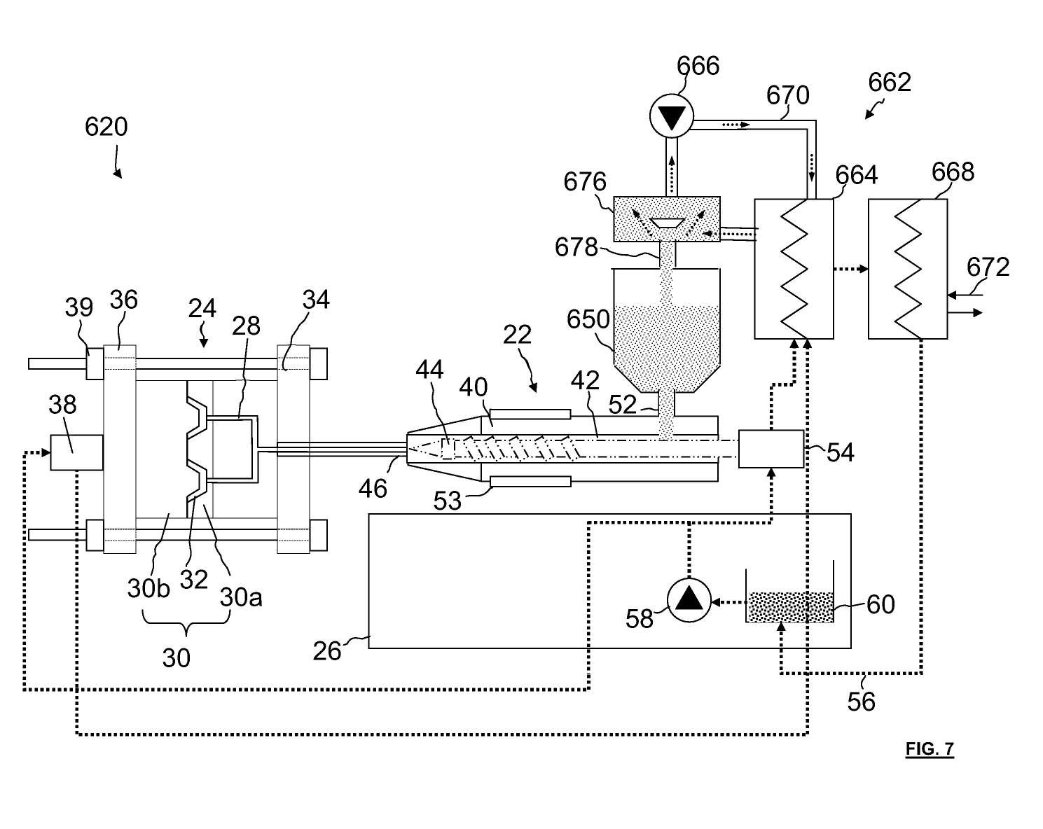

FIG. 7 shows a schematic view of an injection molding machine according to a seventh exemplary embodiment of the invention.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE NON-LIMITING EMBODIMENTS

Referring now to FIG. 1, a resin processing machine, namely an injection molding machine, in accordance with a first exemplary, non-limiting embodiment is shown generally at 20. Injection molding machine 20 is adapted to receive a supply of resin material, melt the resin material and inject the now-molten resin material into a mold. The injection molding machine 20 typically includes an injection unit 22 and a mold unit 24. The injection unit 22 is mounted to a base cabinet 26.

The mold unit 24 includes a hot runner 28 which distributes the molten resin material into a mold 30. The mold 30 may have a single cavity 32 or multiple cavities 32, and in the presently-illustrated embodiment, two cavities 32 are shown. The mold 30 includes a stationary mold portion 30a that is supported by a stationary platen 34. The mold 30 also includes a movable mold portion 30b that is supported by a movable platen 36 that is movable relative to the stationary platen 34. The movable platen 36 is connected to an actuator 38 and the actuator 38 is used to stroke or to move the movable platen 36. In the presently-illustrated embodiment, actuator 38 is a hydraulic actuator. Clamp locks 39 are provided to keep the two mold parts 30a and 30b together during injection. In the presently-illustrated embodiment, the clamp locks 39 are also hydraulically motivated.

The injection unit 22 includes an extrusion barrel 40 which defines a melt channel 42 for the resin material. Extrusion barrel 40 is adapted to receive an injection screw 44. A machine nozzle 46 connects extrusion barrel 40 to the hot runner 28 on mold unit 24. Resin material (typically thermoset or thermoplastic pellets) is stored, prior to its use, in a hopper 50 located above extrusion barrel 40.

Hopper 50 can include auxiliary desiccant or heating equipment (not shown) used to pre-process the resin prior to it being fed into melt channel 42. While hopper 50 is depicted as a single container, those of skill in the art will recognize that hopper 50 can include multiple containers designed for different stages of pre-processing. FIG. 7 shows an example of auxiliary equipment being mounted to hopper 50, and is described in greater detail below. While the presently-illustrated injection unit 22 is directed towards plastic resin materials, it should be recognized that the invention is adaptable to injection units for other types of materials such as magnesium pellets for metal molding.

The resin material is fed from hopper 50, through a feed throat 52 into melt channel 42. The rotational movement of screw 44 melts the resin prior to it exiting through nozzle 46. Heater bands 53 are provided along the length of extrusion barrel 40 to improve heating of the resin material. In addition to rotating, screw 44 is preferably operable to reciprocate back and forth to express the melted material out through nozzle 46 and pack the material within the mold 30. The rotational movement of screw 44 is provided by an actuator 54, which in the presently-illustrated embodiment is a hydraulic motor. Injection of the molten material is provided by translating screw 44 within extrusion barrel 40 via a piston coupled to screw 44. In the presently-illustrated embodiment, the piston is a hydraulically-actuated piston defined within actuator 54.

A hydraulic circuit 56 (indicated by the dotted lines in FIG. 1) provides power to the hydraulically-motivated components in injection unit 22. Hydraulic circuit 56 includes a hydraulic pump 58 which draws the hydraulic fluid from a tank 60 (located within base cabinet 26), and provides fluid pressure to move hydraulic fluid through hydraulic circuit 56, powering components such as actuator 38 and actuator 54 before returning it to tank 60. Hydraulic circuit 56 also provides fluid pressure to clamp locks 39; however, for the sake of clarity of illustration, the dotted lines have been omitted.

As the hydraulic fluid moves through injection molding machine 20, it heats up and will require cooling prior to returning to tank 60 for maximal operating efficiency. A heat exchanger assembly 62 is provided to extract the excess heat from the hydraulic fluid in hydraulic circuit 56 prior to it returning to tank 60. In addition to cooling the hydraulic fluid for reuse, heat exchanger assembly 62 uses the waste heat to preheat the resin stored in hopper 50.

In a typical usage scenario, the hydraulic fluid stored in tank 60 would be at a temperature of approximately 50° C. after a short period of operation for injection molding machine 20. Upon passing through injection molding machine 20 and returning to tank 60, the hydraulic fluid would heat up to a temperature of approximately 60° C. (prior to passing through heat exchanger assembly 62).

In the presently-illustrated embodiment, heat exchanger assembly 62 includes a first heat exchanger 64, a blower 66, and a second heat exchanger 68.

The heated hydraulic fluid exits injection unit 22 and mold unit 24, and passes into the first heat exchanger 64, which in the presently-illustrated embodiment is an oil-to-air heat exchanger. In the presently-illustrated embodiment, the hydraulic fluid has just passed through the actuator 54, actuator 38 and clamp locks 39, and has reached its maximum temperature. Within the first heat exchanger 64, heat from the hydraulic circuit 56 is transferred to an adjacent air circuit 70. The blower 66 circulates the heated air in air circuit 70 through into hopper 50, where it heats up the stored supply of resin material. The air cools as it exits hopper 50, and is returned into the first heat exchanger 64.

After transferring waste heat to air circuit 70 in the first heat exchanger 64, the hydraulic circuit 56 passes through a second heat exchanger 68, which is preferably illustrated embodiment is an oil-to-water heat exchanger. Within the second heat exchanger 68, heat from the hydraulic circuit 56 is transferred to an adjacent water circuit 72. After this further treatment, the hydraulic fluid in hydraulic circuit 56 is at, or approaches its starting temperature, and is returned to tank 60.

The inventors have determined that the invention can provide significant energy savings. For example, PET plastic resin is often stored in outdoor silos, and normally can enter hopper 50 at an incoming temperature of 15° C. If the hydraulic fluid in hydraulic circuit 56 leaves injection unit 22 at a temperature of 60° C., first heat exchanger 64 can raise the temperature of the PET resin to approximately 50° C. (i.e., a gain of 35° C.), resulting in pre-processing energy savings.

Those of skill in the art will recognize that adaptations can be made to heat exchanger assembly 62. Referring now to FIG. 2, a second embodiment of the invention is shown at 120. In injection molding machine 120, a hydraulic circuit 156 is routed along length of extrusion barrel 40 to absorb additional waste heat radiating from heater bands 53 prior to entering heat exchanger 62.

Referring now to FIG. 3, a third embodiment of the invention is shown generally at 220. In injection molding machine 220, a hydraulic circuit 256 is adapted so that actuator 38 drains directly to tank 60, rather than passing through heat exchanger 62.

Referring now to FIG. 4, a fourth embodiment of the invention is shown generally at 320. In injection molding machine 320, the mold unit 324 is not powered by pump 358. Instead, it is powered by its own hydraulic power pack (not shown) or via an electric motor (also not shown). A hydraulic circuit 356 is adapted so that hydraulic fluid is routed only through the injection unit 22.

Referring now to FIG. 5, a fifth embodiment of the invention is shown generally at 420. In injection molding machine 420, the air circuit is omitted from the first heat exchanger 464. Instead, the first heat exchanger 464 routes portions of hydraulic circuit 456 directly through hopper 450 to directly transfer heat from the hydraulic fluid to the resin material. The second heat exchanger 468 could be passively-air cooled (as shown), rather than use a water circuit or omitted entirely (not illustrated).

Referring now to FIG. 6, a sixth embodiment of the invention is shown generally at 520. In injection molding machine 520, a hydraulic circuit 556 is used to motivate components of injection molding machine 520, but is routed so that the hydraulic fluid returns to tank 60. A secondary hydraulic circuit 574 (indicated by the dashed lines in FIG. 6) routes the heated hydraulic fluid to a heat exchanger assembly 562. The secondary hydraulic circuit 574 includes a secondary hydraulic pump 558 to motivate the heated hydraulic fluid in secondary hydraulic circuit 574. Preferably, the secondary hydraulic pump 558 is engaged some time after the hydraulic pump 558 has engaged so that the hydraulic fluid in tank 60 has warmed up due to circulation through the injection molding machine 520. As with the previous embodiments, once passing through the heat exchanger assembly 562, the hydraulic fluid in secondary hydraulic circuit 574 is returned to tank 60.

Referring now to FIG. 7, a seventh embodiment of the invention is shown generally at 620. In injection molding machine 620, the resin material is preheated by a heater exchanger assembly 662 in a pre-heating container 676 prior to entering a hopper 650. Within the first heat exchanger 664, heat from the hydraulic circuit 56 is transferred to an adjacent air circuit 670. The blower 666 circulates the heated air in air circuit 670 through into the pre-heating container 676, where it heats up the stored supply of resin material. The preheated resin material is then fed into hopper 650 via a feed throat 678. After transferring waste heat to air circuit 670 in the first heat exchanger 664, the hydraulic circuit 56 passes through a second heat exchanger 668, which is preferably illustrated embodiment is an oil-to-water heat exchanger. Within the second heat exchanger 668, heat from the hydraulic circuit 56 is transferred to an adjacent water circuit 672. After this further treatment, the hydraulic fluid is returned to tank 60

Other variants of resin processing machines are within the scope of the invention. For example, an injection unit 22 could inject the molten resin material using a shooting pot rather than a translating screw (not shown). Alternatively, the resin-processing machine could have a co-injection design using both a translating screw and a shooting pot (not shown). Alternatively, the invention could be adapted for other resin-processing machine which lack a molding component, such as an extrusion machine adapted to manufacture plastic films.

The invention provides preheating of resin material using waste heat generated during the extrusion and/or molding process. The description of the non-limiting embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the non-limiting embodiments, it will be apparent that modifications and enhancements are possible without departing from the concepts as described. Therefore, what is to be protected by way of letters patent are limited only by the scope of the following claim

What is claimed is:

1. A resin-processing machine operable to process resin material, comprising:
a hydraulic circuit operable to circulate hydraulic fluid through the resin-processing machine to motivate components of the resin-processing machine; and
a heat exchanger assembly, operable to extract heat from at least a portion of the hydraulic fluid; and wherein
the heat exchanger assembly transfers at least a portion of the heat extracted from the hydraulic fluid to the resin material prior to processing of the resin material by the resin-processing machine.

2. The resin-processing machine of claim 1, wherein the resin material is stored in a hopper mounted to the resin-processing machine.

3. The resin-processing machine of claim 2, wherein the heat exchanger assembly includes a first heat exchanger.

4. The resin-processing machine of claim 3, wherein the first heat exchanger is an oil-to-air heat exchanger.

5. The resin-processing machine of claim 4, wherein air heated by the oil-to-air heat exchanger is directed into the hopper.

6. The resin-processing machine of claim 3, wherein the heat exchanger assembly includes a second heat exchanger.

7. The resin-processing machine of claim 6, wherein the second heat exchanger is an oil-to-water heat exchanger located downstream of the first heat exchanger on the hydraulic circuit.

8. The resin-processing machine of claim 6, wherein the second heat exchanger passively cools the hydraulic circuit.

9. The resin-processing machine of claim 3, wherein the first heat exchanger preheats resin material stored in a pre-heating container.

10. The resin-processing machine of claim 1, wherein the hydraulic circuit passes through the heat exchanger assembly prior to returning the hydraulic fluid to a tank.

11. The resin-processing machine of claim 1, wherein a secondary hydraulic circuit circulates the hydraulic fluid from a tank to the heat exchanger assembly.

12. The resin-processing machine of claim 1, wherein the resin-processing machine is an injection molding machine.

13. A heat exchanger assembly, operable to extract heat from a hydraulic circuit after having passed through an resin-processing machine, and wherein
the heat exchanger assembly transfers at least a portion of the heat extracted from the hydraulic circuit to a supply of resin material prior to processing of the resin material by the resin-processing machine.

14. The heat exchanger assembly of claim 13, wherein the heat exchanger assembly includes a first heat exchanger.

15. The heat exchanger assembly of claim 14, wherein the first heat exchanger is an oil-to-air heat exchanger.

16. The heat exchanger assembly of claim 15, wherein air heated by the oil-to-air heat exchanger is directed into a hopper storing resin material.

17. The heat exchanger assembly of claim 15, wherein the heat exchanger assembly includes a second heat exchanger.

18. The heat exchanger assembly of claim 17, wherein the second heat exchanger is an oil-to-water heat exchanger located downstream of the first heat exchanger on the hydraulic circuit.

19. The heat exchanger assembly of claim 17, wherein the second heat exchanger passively cools the hydraulic circuit.

20. The heat exchanger assembly of claim 14, wherein the first heat exchanger preheats resin material stored in a pre-heating container.

21. A method for preheating a supply of resin material prior to its processing in a resin-processing machine, the method comprising:
transferring heat from the resin-processing machine to hydraulic fluid in a hydraulic circuit located within the resin-processing machine;
circulating the hydraulic fluid into a heat exchanger assembly;
transferring heat from the hydraulic circuit to the supply of the resin material via the heat exchanger assembly.

22. The method of claim 21, wherein the resin material is stored in a hopper mounted to the resin-processing machine.

23. The method of claim 21, wherein the heat exchanger assembly preheats resin material stored in a pre-heating container.

24. The method of claim 21, wherein the hydraulic circuit passes through the heat exchanger assembly prior to returning the hydraulic fluid to a tank.
